(19) United States
(12) Patent Application Publication
(10) Pub. No.: US 2011/0292406 A1
(43) Pub. Date: Dec. 1, 2011

(54) SCANNER WITH FEEDBACK CONTROL

(75) Inventors: Karl-Josef Hollenbeck, Kobenhavn O (DK); Henrik Öjelund, Lyngby (DK); Christopher Simon Edwards, Middlesex (GB); Alfredo Chávez Plascencia, Aalborg (DK); Rune Fisker, Virum (DK)

(73) Assignee: 3Shape A/S, Kobenhavn K (DK)

(21) Appl. No.: 13/126,287

(22) PCT Filed: Oct. 28, 2009
(86) PCT No.: PCT/DK2009/050281

§ 371 Date: Aug. 17, 2011

(30) Foreign Application Priority Data
Oct. 28, 2008 (DK) PA2008 01484

(51) Int. Cl. G01B 11/24

(52) U.S. Cl. 356/607

(57) ABSTRACT

The present invention relates to non-contact optical scanning of an object for generation of a three-dimensional surface model of the scanned object. In particular the invention relates to a scanner for obtaining the three-dimensional geometry of at least a part of the surface of an object, said scanner comprising: —at least one light source, preferably a laser light source with adjustable power, —projection means for directing light from the at least one light source to a moving spot on the surface of the object, —at least one image sensor adapted to record at least one image of at least a part of the surface, —detection means, other than the at least one image sensor, for monitoring at least a part of the light reflected from the surface, —regulation means for adjusting the intensity of the at least one light source based on the amount of light reflected from the surface, and—means for transforming the at least one image to a three-dimensional model of the surface.

The present invention relates to non-contact optical scanning of an object for generation of a three-dimensional surface model of the scanned object.

### BACKGROUND OF THE INVENTION

Laser scanners are widely used for many applications, both physically altering the scanned object (fine engraving, welding) or for detecting surface properties (bar code reading, digital three-dimensional surface reconstruction. The basic principle of a laser scanner is to direct a beam at the scanned object. By using optical elements such as lenses or mirrors, the beam can be directed in some spatial pattern, for example a line.

A method for producing a digital three-dimensional model of a physical object is to direct a laser beam onto the surface of the object and record the image with a camera from a different angle. When the relative positions and the internal parameters of the beam generator and the camera are known, the three-dimensional shape of the illuminated part of the object can be computed using triangulation. An improvement of the principle is to use multiple cameras and check the consistency of the triangulation results from each. Scanners used for these purposes are termed “3D scanners.”

When directed by one or more rapidly moving mirror(s), the laser beam will appear as a linear pattern in the image, provided the image exposure time is long enough. The above triangulation can then be performed for the entire linear pattern (possibly discretised into points or segments), such that the three-dimensional model of the object can be acquired from fewer images and thus faster. Another way to more rapidly acquire a full three-dimensional model is to move the object while it is scanned, acquiring images continuously.

A problem typically encountered with optical scanners is that the laser beam cannot be properly identified in the image, and thus the triangulation becomes inaccurate. The image is generally acquired with a digital camera, where the intensity of the reflected light is measured in each pixel. The dynamic range of pixel values is generally limited, often to values between 0 and 255. When the scanned object is not made of a single material, and/or when reflection of light is specular, the image intensity will generally be non-uniform. Some pixels in the image may be saturated, while others may fail to detect a weak reflection.

Feedback control of laser power is known in the art. U.S. Pat. No. 6,067,306 describes a semiconductor wafer fabrication system, however pulses of light are used rather than a continuous source. In U.S. Pat. No. 5,307,198 the beam is split into a pilot and refracted beam, with the latter providing the control signal for the former. U.S. Pat. No. 4,256,959 describes an optical scanner with feedback control, however for two-dimensional documents only. U.S. Pat. No. 6,057,537 relates to feedback control in drum-type scanners that direct a laser at a photosensitive film. The regulation is however based on a portion of the incident beam, not the reflection.

WO 2007/125081 relates to a stripe scanning probe for obtaining the shape of an object by means of a light stripe and a camera detecting the light reflected from the object surface. The scanning probe comprises means for adjusting the intensity of the light stripe, in dependence upon the intensities detected by the camera.

### SUMMARY OF THE INVENTION

While the intensity of the light in the scanner according to WO 2007/125081 is adjusted to account for the limited dynamic range of the camera, the intensity of the light can only be adjusted after the light has been detected by the camera because the adjustment is dependent upon the intensities detected by the camera.

An object of the invention is therefore to provide a scanner with the ability of adjusting the intensity of the light to account for the limited dynamic range of image sensors, however without being dependent upon the amount of light detected in the image sensor. This is achieved by a scanner for obtaining the three-dimensional geometry of at least a part of the surface of an object, said scanner comprising:
at least one light source, preferably a laser light source with adjustable power,
projection means for directing light from the at least one light source to a moving spot on the surface of the object,
at least one image sensor adapted to record at least one image of at least a part of the surface,
detection means, other than the at least one image sensor, for monitoring at least a part of the light reflected from the surface,
regulation means for adjusting the intensity of the at least one light source based on the amount of light reflected from the surface, and
means for transforming the at least one image to a three-dimensional model of the surface.

The invention furthermore relates to a method for obtaining the three-dimensional geometry of at least a part of the surface of an object, said method comprising the steps of:
projecting light from at least one light source to a moving spot on the surface of the object, said at least one light source preferably being an adjustable laser light source,
recording at least one image of at least a part of the surface by means of at least one image sensor, and
monitoring at least a part of the light reflected from the surface by means of at least one detector other than the at least one image sensor,
adjusting the intensity of the at least one light source based on the amount of light reflected from the surface, and
transforming the at least one image to a three-dimensional model of the surface.

The present invention provides a scanning system and a method that can adjust the power of the laser beam such that the recorded intensity in the image can be maintained within the image sensor's dynamic range. The important aspects in this invention are that the feedback control of laser power is independent of the image sensor (camera) system, and that there is no time lag between the image acquisition and the intensity regulation. This advantage can for example be achieved by using a photodiode to supply the feedback control input.

The present invention furthermore significantly expands the application areas of 3D scanners, namely to objects with heterogeneous surface reflectivity. Such heterogeneity occurs, e.g., in composite objects made out of different materials, or objects painted in different colours. Even most homogeneous materials, especially metals, are non-lambertian, i.e., their reflectivity is effectively heterogeneous as it depends on the viewer' angle. Accordingly, traditional 3D scanners require many objects to be coated with a diffusely reflecting agent, often by spraying. This process implies a health risk (small aerosol particles, solvents), and the thickness of the applied layer is difficult to control. The intensity adjustment described in the present invention can make coating obsolete in many cases. Therefore, this invention is particularly attractive for 3D inspection within for example industrial applications, medical applications, and other fields of application.

### DETAILED DESCRIPTION OF THE INVENTION

Unlike the optical scanning probe described in WO 2007/125081, this invention relies on a single element detector detecting scattered light from a single, continuously moving spot of light. Neither the generated line of light nor the detector(s) are pixellated, and this technique does not rely on spatial information from the camera or photodiode modules. The feedback control is wholly independent of information from the camera image. Neither is this invention necessarily “digital” in the sense the word is used on page 19 of WO 2007/125081. Either analogue signal processing electronics comprising discrete components can be used or else a digital version of the feedback control can be realised using a field-programmable gate array (FPGA), application specific integrated circuit (ASIC), a application specific standard product (ASSP) or a PC. A mixed signal circuit implementation would also be an embodiment of this invention.

One embodiment of the present invention overcomes the laser line detection problem by way of feedback control of the laser power, thus achieving images where the intensity of the reflected light is within the dynamic range of the sensors. It uses projection means for directing the laser beam, and detection means other than the camera to monitor the reflected light. A key advantage is that the regulation can be much faster than the camera frame rate, so there is no frame delay between detection and regulation. Under optimal conditions, there is not even a sub-frame (image pixel) delay. Such fast feedback control is advantageous when scanning objects with surfaces whose reflectivity varies at small spatial scales (relative to the length of the laser linear pattern). The advantage is even more pronounced when the object being scanned is moved during scanning. Attempts of using the information in images for an earlier position to control laser intensity in a subsequent position have not given acceptable results in such cases.

Various embodiments of this invention have several additional benefits relative to a laser line generated by a cylindrical lens: a reduction in speckle, an improved beam profile, thermal isolation, and a reduction in motion blur when the object being scanned is moved during scanning.

In a preferred embodiment of the invention the light source is preferably adjustable to account for the limited dynamic range of an image sensor, however any adjustment of the intensity of the light source is provided independently of the image sensor. Adjustment of the intensity of the light source is preferably provided as a result of monitoring of light reflected from the surface, where the monitoring of light is provided by the detection means. The detection means preferably comprises at least one photodiode.

Light from the at least one light source is preferably projected as a moving spot by means of at least one mirror, e.g. a galvanometric mirror, adapted to perform at least a rotational movement.

The local intensity of the light on the surface, i.e. the intensity within an area of the surface, can be adjusted by means of varying the motion of the moving spot. I.e. the faster the spot moves, the lower the local intensity. In one embodiment of the invention the projection means can be adjusted to vary the local intensity of light on the surface of the object. This adjustment can preferably be provided by the regulation means. One way of varying the local intensity on the surface is by varying the angular movement of the at least one mirror.

The at least one the image sensor in this invention is preferably a part of at least one camera.

In a preferred embodiment of the invention the power of the at least one light source can be adjusted faster than the frame rate of the at least one image sensor, preferably more than 2 times, more than 10 times, more than 50 and most preferably more than 100 times faster than the frame rate of the at least one image sensor. This ensures that there is no time lag between the image acquisition and the intensity regulation.

The intensity of the at least one light source is preferably adjusted by means of at least one feedback control system, for example a feedback control system based on the output from at least one photodiode measuring at least a part of the light reflected from the surface.

The at least one image is preferably transformed to a three-dimensional model of the surface by means of at least one data processor.

To be able to acquire the surface geometry of whole objects, the object must be moved relative to the projected light and the image sensor. Preferably this is provided by movement of the object, thus means for translation and/or rotation of the object relative to the projected light and the at least one image sensor is preferably comprised. Preferably images are acquired by the image sensor for many positions during translation and/or rotation of the object, each image being transformed to a part of the three-dimensional model of the surface. In the special case of a region of the object's surface being represented by multiple images, averaging is preferably applied to derive a unique model of the surface.

Even though the at least one image sensor and the detection means operate independently, it is preferred that the points of observation of the detector and the image sensor are as close as possible. This can be provided if the detection means is semi-transparent and located co-axial with the at least one image sensor. Another solution could be if the detection means are semi-transparent and located inside and/or adjacent to the at least one image sensor, preferably located behind a lens and in front of at least one image sensor. Yet another solution could be with the detection means monitoring the light reflected from at least one beam-splitter, where the beam-splitter is preferably located co-axial with at least one image sensor. Co-axiality of image sensor and detection means is however not a requirement. In other embodiments, multiple photodiode modules are placed in any combination of the above placements.

At least one optical fibre can preferably be provided as a way of transporting the light between the at least one light source and the projection means. Preferably a single-mode optical fibre is used. In one embodiment of the invention spatial filtering is provided through the use of a pigtailed laser diode, spatial filtering is preferably provided to the light before the light is projected on to the object by the projection means.

Some information of the object shape may be known prior to scanning. This prior information can preferably be provided to the scanner before scanning. For example prior information in terms of a CAD model of the object. This prior information can optimise the scan routine and possibly lower the time necessary for scanning of the object.

In one embodiment of the invention a plurality of light sources is comprised, the plurality of light sources preferably providing light at different wavelengths. Preferably the plurality of light sources can be applied one at a time.

At least one optical band pass filter can be provided, for example if the filter has a wavelength transparency window that at least comprises the wavelength of the light source while rejecting unwanted background light. Thereby substantially only the wavelength of the light source is allowed to pass whereby it may be possible to use the scanner in ambient light conditions.

Preferably the scanner according to the invention comprises means for exposing only part of the at least one image sensor. Furthermore the at least one image sensor is preferably synchronised with the projection means. When combined with a rolling shutter, preferably synchronised with the motion of the moving spot, means for synchronising the motion of the moving spot with the reading of at least one image sensor is provided. A rolling shutter exposes only part of the at least one image sensor. Said at least one image sensor preferably comprises an image sensor array. Thus, a rolling shutter will expose only a subset of the rows and/or columns of the image sensor array.

A particular advantage of the scanning mirror can be realized when the image sensor is a pixel array and the object or the scanner is moved during the acquisition of images. In this constellation, the motion of the moving beam spot can be synchronized with the reading of sections within the pixel array. Each section of pixels then has an effective exposure time shorter than that of an entire frame, but still capturing substantially the same amount of light as it would for the entire frame's exposure time. Thereby motion blur in the image can be reduced. Another advantage is that the feedback control electronics can become easier and/or cheaper to realize when the beam spot makes only one sweep over the imaged area during one frame.

### DRAWINGS

The invention will now be described in more detail with reference to the drawings, in which

FIG. 1: is an overview of the invention. It represents one embodiment of the invention, with a single photodiode module placed next to a camera.

FIG. 2A is a front view of the line generator module, said module being a particular embodiment of the laser light source 102 of FIG. 1.

FIG. 2B is a top view of the line generator module.

FIG. 3: is a photodiode module, which is a photodiode with a pre-amplifier circuit.

FIG. 4: is a feedback control system with a semi-transparent photodiode placed co-axially with a camera, behind the camera's lens, but in front of the camera's image sensor.

FIG. 5: is a feedback control system with a semi-transparent photodiode placed co-axially with a camera, in front of the camera's lens.

FIG. 6: is a feedback control system with a beam-splitter placed co-axially with a camera, and a photodiode module placed in the direction of the beam-splitter's reflection.

FIG. 7: is a feedback control system with multiple photodiode modules placed next to a camera.

FIG. 8: illustrates three possible placements of multiple photodiode modules (or an annular photodiode) relative to a camera.

FIG. 9: shows some experimental results that demonstrate the effectiveness of this invention.

FIG. 10: shows further experimental results also demonstrating the effectiveness of this invention.

### DETAILED DESCRIPTION OF THE DRAWINGS

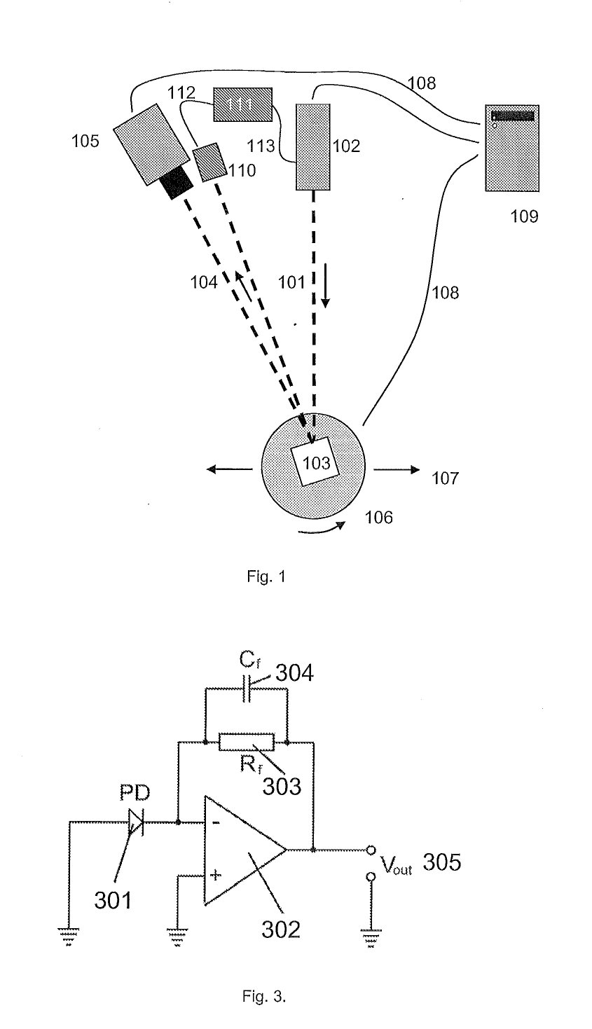

Many scanner systems basically function the same way, see FIG. 1: A monochromatic or multi spectral light pattern 101 such as laser dots, laser lines, white or coloured stripes, is projected from a light source 102 onto the object 103. The projected light is then reflected 104 and one or more cameras 105 acquire images of the projection.

For a preferred embodiment of this invention, the light source 102 must be one whose intensity can be regulated at high frequencies. In this context, “high” means at least 100 times the frame rate of the camera 105. Lasers—who's input power can be modulated—generally fulfil this requirement. In the following description of various embodiments of the scanner according to the invention, it is therefore assumed that 102 is a laser light source.

In 3D scanners, the above mentioned light pattern is detected in the image and well established projection geometry such as triangulation or stereo is used to derive the 3D coordinates, e.g. a line laser is projected onto the object forming a line. The 3D coordinates are then reconstructed along that particular line. The scanner may contain one or more light sources and one or more cameras.

In 3D scanners, the next step is then to move the object and scanner relative to each other e.g. by rotation 106 or linear motion 107 of the object 103. This way the 3D scanner can reconstruct the surface on a new part of the object, e.g. a new line on the surface in the line laser example.

Camera, light source and motion system are all connected 108 to some controlling electronic equipment (usually a computer) 109, which communicates with and controls each component. The computer 109 might be a separate unit or integrated into the scanner.

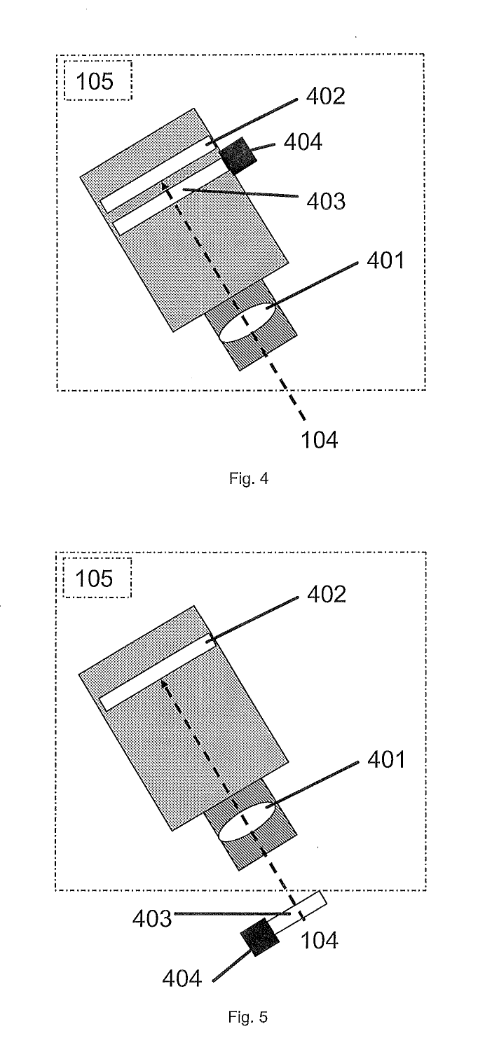

This invention differs from the prior art in the regulation of the power of the laser light source 102 by feedback control, given the signal detected by a photodiode module 110. This photodiode module also captures the reflected light 104. The photodiode module's output 112 is sent to signal processing electronics 111, which then continuously regulate the power of the light source via connection 113. The placement of a single photodiode module 110 as shown in FIG. 1 is only one embodiment of this invention; other examples are illustrated in FIGS. 4, 5, 6, 7, and 8.

The photodiode module 110 typically consists of a photodiode and generally a trans-impedance pre-amplifier. In one embodiment of the invention, the pre-amplifier is integrated within the photodiode itself, in another embodiment the pre-amplifier is made from discrete circuit components.

The motion system 106, 107 is not an essential part of the invention. For example, one embodiment of this invention could be a scanning probe composed of light source 102, one or more cameras 105, photodiode(s) 110, and signal processing electronics 111, with connections 112 and 113. This scanning probe could then be mounted on an external motion system, for example a Coordinate Measurement Machine.

### Line Generator Module

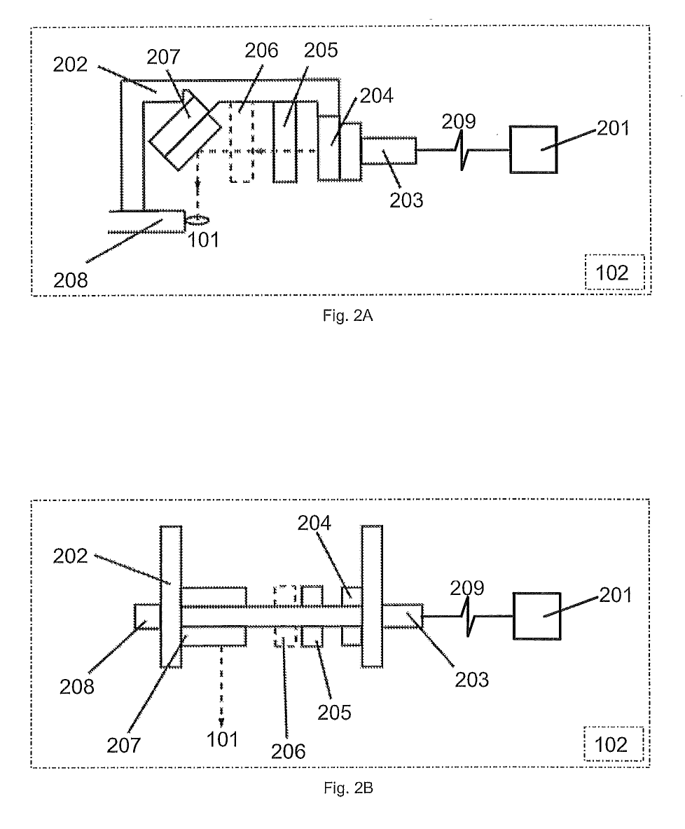

A particular embodiment of the light source 102 of FIG. 1 is described in detail in the following, and also shown in FIGS. 2A and 2B. It uses a galvanometric scanning mirror assembly (hereafter referred to as a scanning mirror) to rapidly project a spot, thus effectively appearing as a quasi-continuous line of light, onto an object to be scanned. In the following this assembly is termed “line generator module”. In one embodiment of the invention the line generator module consists of a pig-tailed laser diode 201, a mounting frame 202, a fibre collimator 203 connected to a pig-tailed laser diode 201 and its controller, an adjustable mount 204, a focusing lens 205 (with an optional additional lens 206), a beam-steering mirror 207 and the scanning mirror 208, giving the projected light pattern 101 also shown in FIG. 1. Note that in FIG. 2A, the projected light pattern leaves the line generator module in the direction normal to the drawing plane. The optical fibre 209 connects the laser diode with the fibre collimator 203. The fibre is generally much longer than the wavelength of the light, preferably longer by a factor of at least 10,000.

In one embodiment of the line generator module, the beam steering mirror 207 is a galvanometric scanning mirror assembly, but it could also be a rotating mirror with one or multiple facets, or a set of mirrors. Acousto-optical modulators/deflectors (AOM) could also be used for fast beam sweeping.

In the described embodiment of a line generator module, the pig-tailed laser diode 201 can easily be replaced by another of different wavelength, or both the laser diode 201 and the fibre 209 can be replaced. Besides from switching light source manually, an elegant solution is to combine two or more wavelengths of laser light on a dichroic mirror either after but preferably before the optical fibre 209. This enables the line generator module to operate with different wavelengths and switching between these wavelengths temporally without physical changes to the module. In this fashion differences in the absorptive and/or reflective properties of the scanned material with respect to wavelength can be exploited. Alternatively a fibre coupler may be used instead of the dichroic mirror (e.g. a 2×2 coupler or a 2×1 coupler). Furthermore, a laser diode with shorter wavelength can achieve a narrower beam width for a given depth of focus, improving the triangulation of the 3D scanner. The additional lens 206 can be used to compensate for differences in focusing properties of different wavelengths. For example, it can be flipped into and out of the beam. Alternatively, a single voltage-tunable lens (e.g. of the kind used in cellular telephone cameras) can be used in place of the two lenses 205 and 206.

### Photodiode Module

One embodiment of the photodiode module 110 is shown in detail in FIG. 3. It comprises a photodiode (PD 301) with a trans-impedance pre-amplifier (typical electronic schematic shown in FIG. 3, using an operational amplifier 302, where the trans-impedance gain is set by the value of feedback resistor R_{f} 303 and the feedback capacitor C_{f} 304 is used to set the amplification bandwidth; the output signal is a voltage Vₒᵤₜ 305). In one embodiment of the invention the pre-amplifier is integral within the photodiode itself, in another embodiment the pre-amplifier is made from discrete circuit components.

### Feedback Control

The technique of feedback control is commonly used in the field of atomic spectroscopy where it is called “optical power stabilisation” (see e.g. [1]). In general, the techniques employed aim to stabilise the optical power incident on the spectroscopic sample under illumination. However, an alternative approach, adopted in this invention, is to stabilise the scattered optical power level. In experimentally demonstrating this invention we have employed some analogue feedback control circuitry, designed and developed for a two-photon rubidium optical frequency standard for use at 778 nm [1], to stabilise the optical power incident on a photodiode.

Various embodiments of this invention differ with respect to the placement and/or number of the photodiode module(s) 110. The type of photodiode 110 can also differ in the various embodiments. In all embodiments, the photodiode module(s) 110 are used to detect scattered light from the object 103 being scanned by the output of the laser light source 102, with a particular embodiment of said light source 102 being the line generator module of FIGS. 2A and 2B. In all embodiments, the output(s) of the photodiode module(s) 110 provide a feedback signal 117 to the signal processing electronics 111. Details on the various embodiments are disclosed below.

The amplification bandwidth of the photodiode module(s) 110, feedback signal bandwidth and laser diode modulation bandwidth are closely matched for optimum signal-to-noise-ratio (SNR) in relation to overall signal bandwidth. This bandwidth will determine the fastest camera frame-rate achievable for a given spatial resolution. The detected DC light level is compared with a reference level (preset either by the operator or by a PC/FPGA), and a feedback signal applies a real-time correction to the laser output power via the modulation port of the laser diode driver. The feedback control function is a linear summation of proportional, integral and derivative control terms (which may include secondary and tertiary integrators, see e.g. [2]), and the gains and time constants are optimised with the two principal bandwidth limitations (photodiode pre-amplifier bandwidth and diode modulation bandwidth) in mind. The analogue signal processing electronics can be replaced by an equivalent feedback control function implemented in FPGA, ASIC or ASSP (or via a PC).

In case there are multiple cameras 105, each can have its own photodiode module 110. The input to the signal processing electronics 111 should either be the output of one of these photodiode modules 110 (nominated by the operator or PC/FPGA) or a summation of the photodiode signals (summed in ratio set by the operator or PC/FPGA).

### Digital Supervision

Digital supervision of the feedback control can be used to ensure the signal processing electronics output is set to “hold” mode when a discontinuity is detected (e.g. when the laser spot disappears down a hole in the scanned object 103 and no scattered light is incident on the photodiode). These discontinuities can be detected either by monitoring the output of the photodiode module 110 or monitoring the feedback signal. When light is restored on the photodiode 110, the feedback control resumes normal operation.

When scanning an object which is highly absorptive and consequently scatters very little light back to the camera(s) 105, the conventional feedback control described above may fail to give sufficient intensity in the camera images. In such case, the signal processing electronics output would be detected at its maximum permitted value for a significant portion of the time. Then, as a method of last resort, the digital supervision can reduce the angular range of motion of the beam-steering mirror 207. This will reduce the length of the projected line (thus increase the time needed to perform the 3D scan), but also give the appearance of greater intensity in the camera images. Conversely, the digital supervision can increase the length of the projected line for very reflective materials (when the signal processing electronics output would be detected at its minimum permitted value for a significant proportion of the time). Note that unlike the afore-mentioned feedback-control of laser power, a change of motion angle range would only take effect in subsequent image frames. Also, not all embodiments of this invention allow a change in the motion angle range (e.g., a rotating mirror does not).

In some applications of the 3D laser scanner, the geometry of the scanned object may be known at least approximately, for example if a CAD model of the scanned object 103 is provided. Such knowledge, for example about the location of holes from which no reflection can be expected, may be exploited in the digital supervision. Care must however be taken that the a-priori information does not dominate the scanning results, especially in situations where the actual object's 103 geometry deviates from the CAD model.

### Co-Axial Detection

In many respects the most technically elegant embodiment of this invention is to use a semi-transparent photodiode 403 immediately in front of the camera's active array 402, behind the lens 401 (FIG. 4). The semi-transparent photodiode 403 may be separate from the camera array 402, or it may be incorporated as an integral part of the array (as a thin film layered device immediately before the array). The pre-amplifier for the semi-transparent photodiode 403 must be placed such that is does not obstruct the path of light. For reference, note that the semi-transparent photodiode 403 and the pre-amplifier 404 make up the photodiode module 110 in this embodiment. In the configuration of FIG. 4 the photodiode module is thus—unlike in FIG. 1—an integral part of the camera 105.

In embodiment a semi-transparent photodiode 403 is provided immediately before the camera lens 401 (FIG. 5). As in the previous embodiment, the pre-amplifier for the photodiode 404 must be placed such that is does not obstruct the path of light. Again for reference, the semi-transparent photodiode 403 and the pre-amplifier 404 make up the photodiode module 110 in this embodiment.

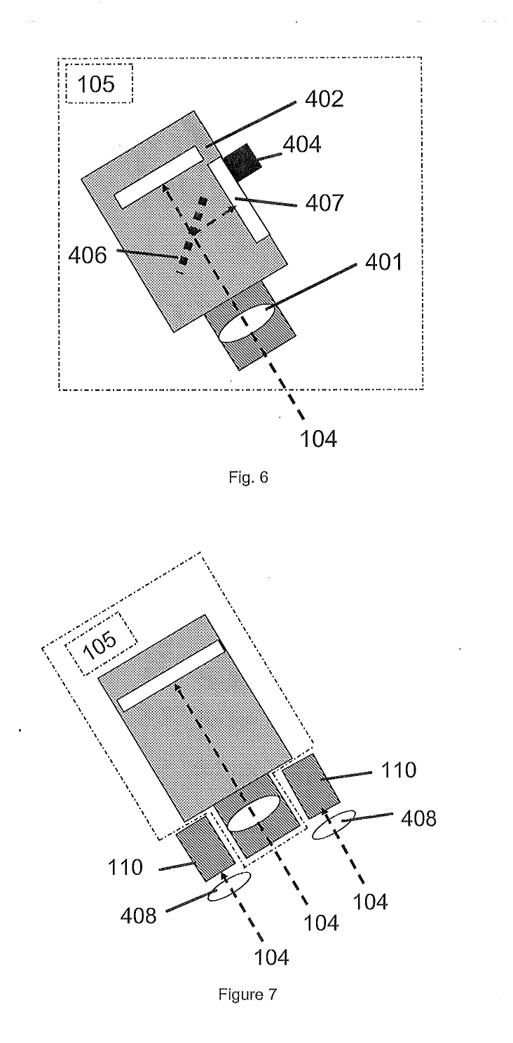

If a semi-transparent photodiode is unavailable and a non-transparent photodiode module must be used, then a beam-splitter 406 may be placed immediately after the camera lens 401 to split the incoming beam into a portion going to the camera array 402 and another going to the non-transparent photodiode 407 (FIG. 6). Alternatively, the pick-off beam-splitter 406 could be placed immediately before the camera lens 401 (in the same sense as is the difference between FIGS. 4 and 5). Where a beam-splitter is used, an optional lens may be added to increase light collection for the non-transparent photodiode 407. Again for reference, the non-transparent photodiode 407 and the pre-amplifier 404 make up the photodiode module 110 in this embodiment.

### Off-Axis Detection

If co-axial location of the photodiode module 110 is not a practical option, it may be acceptable to place it slightly off the optical path to the camera, next to the camera (FIG. 1). An optional lens may be added to increase light collection for the photodiode module 110.

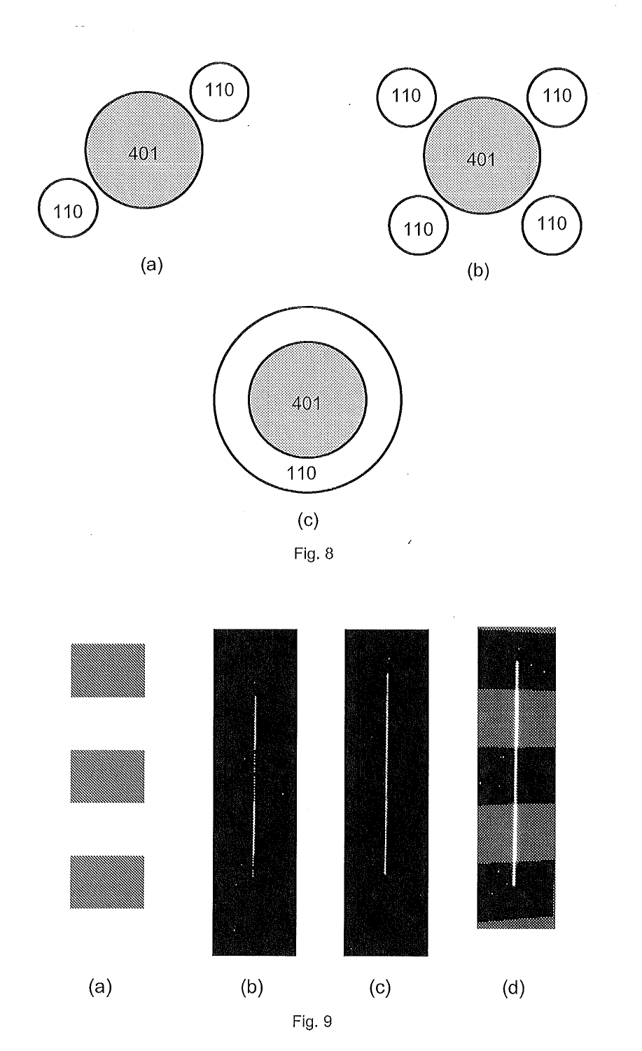

Using an array of photodiode modules 110 grouped around the camera position is expected to give improved performance (FIGS. 7 and 8 (a), 8 (b), with FIG. 8 showing the camera lens 401 from the front). Optionally, lenses 408 may be added to increase light collection for the photodiode modules 110. Another embodiment uses an annular photodiode module 110 co-axially with the camera lens 401 (FIG. 8 (c)).

### Speckle Reduction

The line generator module has been observed to reduce speckle as compared to a laser in which a cylindrical lens is used to generate a line. In this context, speckle was measured as the variance of pixel values in images of the laser line. This variance was reduced by more than 20%. This reduction may be due to averaging effects when the beam sweeps the same surface several times during a frame, with slight differences in path in every sweep (due to mechanical imperfection in the galvanometric scanning mirror). Reduced speckle is beneficial for 3D scanning, as the detection of the beam in the image and thus eventually triangulation becomes more accurate.

### Spatial Filtering

On embodiment of the invention uses spatial filtering of the light source prior to the line generator module in order to improve the beam quality of the scanning spot and hence the optical properties of the generated line. This improved quality results in better spatial resolution and precision of the overall optical scanning, resulting in reduced scatter and dimensional uncertainty in the three-dimensional model of the surface. In one embodiment of the invention the spatial filtering is achieved through the use of a pigtailed laser diode. It is advantageous to use a single-mode optical fibre rather than a multi-mode optical fibre.

### Rolling Shutter

It may be advantageous to synchronize the motion of the laser beam as achieved by the scanning mirror 208 with the reading of the camera array 402. This is possible if said camera array 402 can be read with a rolling shutter, exposing only a subset of rows of pixels sequentially during acquisition of a frame. In this case, the subset of rows can be made to follow the image of the beam spot on the scanned object 103. Each window thus has an exposure time smaller than the frame time, but still collects (almost) as much light as it would if the shutter exposed the entire camera array. One way to synchronize the shutter with the scanning mirror is to set the scanning mirrors sweep frequency equal to the frame rate of the camera array, and then to adjust the phase shift at the scanning mirror until a maximum of light is collected.

When the laser beam and shutter are synchronized, the beam sweeps the same surface only once during a frame, i.e. at the smallest possible speed for which a full image can be obtained. Accordingly, for a given object 103 with non-uniform reflectivity, the rate of change in the signal detected by a photodiode module 110 is smallest, too. Accordingly, the bandwidth requirements for the processing electronics 111 are smallest when beam and shutter are synchronized.

A rolling shutter is particularly beneficial when the scanned object 103 is moved while being scanned, because the degree of motion blur in the images acquired by the camera(s) 105 can be reduced. Moving the object during the scan is desirable because total scan time can be reduced.

### Thermal Isolation

One embodiment of the invention achieves very effective thermal separation of the heat generation associated with the laser source 201 (and its associated electronics) and the remainder of the line generator module. This is achieved by using fibre-optic delivery 209 of the light to the line generator, allowing remote location of the laser source, and the resultant thermal isolation is beneficial both in terms of the dimensional stability of the line generator module and also in removing a heat source from the measurement volume of the 3D scanner. It also isolates a heat source from other heat-sensitive components of the invention, in particular the camera(s).

### Polarizing Optics

For shiny objects, it can be advantageous to place polarizing optics in the light path.

The polarizing optics can be set to enhance the relative contribution of the specular reflection in the signal detected by the photodiode(s) 110 and the images recorded by the camera(s) 105. Preferably, some polarizing optics are used to control the polarization state of in the emitted light 101, and other polarizing optics are inserted to filter the reflected light 104. The filtering effect must be at least very similar for both the camera(s) 105 and photodiode(s) 110 in order for the feedback-control mechanism to work properly.

### Specimen Results

Some results obtained using a slightly offset photodiode module 110 (FIG. 1) are shown in FIG. 9. The scanned object in this case was a sheet of paper with a printed light and dark alternating pattern (FIG. 9 (a)). Without feedback control of laser power (FIG. 9 (b)), the image shows the laser line only in the light areas, where there is sufficient reflection. With feedback control applied (FIG. 9 (c)), the uniformity of the recorded light line is substantially improved. This improvement has also been observed for a variety of materials and surface finishes. FIG. 9 (d) shows the pattern with the room lights on, illuminated without feedback control as in (b), but with higher laser power. In this case, the line becomes visible also on the dark areas, but in the light areas, many pixels image saturate, whereby the line appears wider and thus less suitable for triangulation purposes.

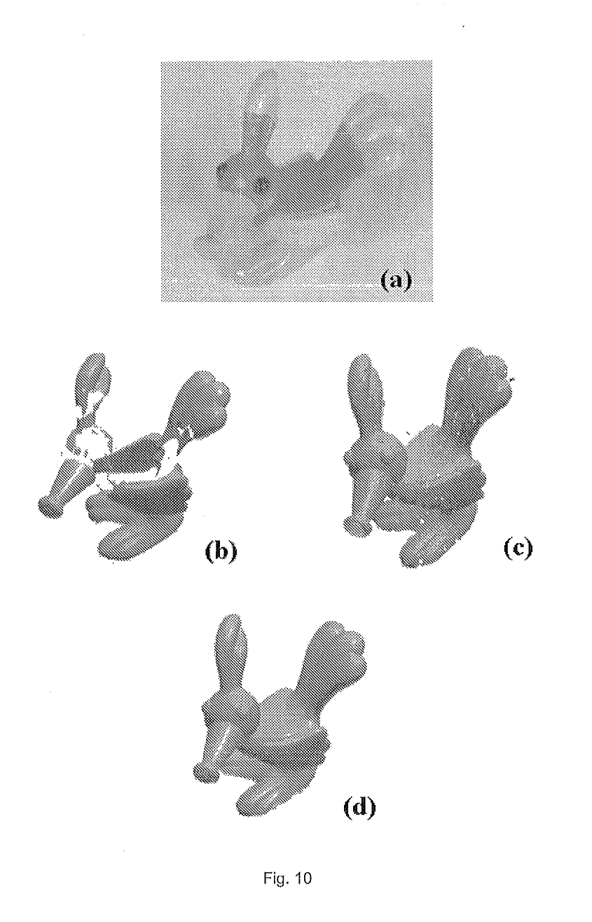

The benefit of the invention for generating 3D models is shown in FIG. 10 for a small toy that has patches of surface with different reflectivity seen from a traditional 2D image of the toy (FIG. 10 (a)). With a traditional 3D scanner with constant pre-set laser light intensity, the user has to choose between two poor alternatives. Either the user can choose a low intensity, yielding a good 3D surface model of the highly reflective patches, but with holes for the dark patches (FIG. 10 (b)). Alternatively, the user can choose a high intensity, avoiding any holes, but at the expense of a noisy (rough) surface representation of the highly reflective patches due to saturation in the underlying scanner images (FIG. 10 (c)). The scanner according to this invention, in contrast, captures all surfaces well and thus yields a good complete 3D model (FIG. 10 (d)).

### REFERENCES

[1] C. S. Edwards, G. P. Barwood, H. S. Margolis, P. Gill and W. R. C. Rowley, “Development and absolute frequency measurement of a pair of 778 nm two-photon rubidium standards”, Metrologia, 42, 464-467 (2005).
[2] J. Helmcke, S. A. Lee and J. L. Hall, “Dye laser spectrometer for ultrahigh resolution: design and performance”, Applied Optics, 21, 1686-1694 (1982).

The invention will be now be described in further detail by means of the following items:

1. A scanner for obtaining the three-dimensional geometry of at least a part of the surface of an object, said scanner comprising:
a. at least one light source, preferably a laser light source with adjustable power,
b. projection means for directing light from the at least one light source to a moving spot on the surface of the object,
c. at least one image sensor adapted to record at least one image of at least a part of the surface,
d. detection means, other than the at least one image sensor, for monitoring at least a part of the light reflected from the surface,
e. regulation means for adjusting the intensity of the at least one light source based on the amount of light reflected from the surface, and
f. means for transforming the at least one image to a three-dimensional model of the surface.

2. A scanner according to item 1, wherein the detection means monitors light independent of the at least one image sensor, and/or wherein adjustment of the intensity of the light source is provided independently of the image sensor.

3. A scanner according to any of the preceding items, wherein the light is projected as a moving spot by means of at least one mirror adapted to perform at least a rotational movement.

4. A system according to item 3, wherein at least one mirror is a galvanometric mirror.

5. A scanner according to any of the preceding items, wherein the projection means can be adjusted to vary the local intensity of light on the surface of the object.

6. A scanner according to any of the preceding items, wherein the projection means can be adjusted by the regulation means.

7. A scanner according to any of the items 3 to 6, wherein the projection means are adjusted by means of varying the angular movement of the at least one mirror.

8. A scanner according to any of the preceding items, wherein the moving spot appears as a pattern, such as a linear pattern, on the surface of the object.

9. A scanner according to any of the preceding items, wherein the image sensor is a part of a camera.

10. A scanner according to any of the preceding items, wherein power of the at least one light source can be adjusted faster than the frame rate of the at least one image sensor, preferably more than 2 times, more than 10 times, more than 50 and most preferably more than 100 times the frame rate of the at least one image sensor.

11. A scanner according to any of the preceding items, wherein light reflected from the surface is detected by means of at least one photodiode.

12. A scanner according to any of the preceding items, wherein the intensity of the at least one light source is adjusted by means of at least one feedback control system.

13. A scanner according to item 12, wherein the feedback control system adjusts the intensity of the at least one light source based on the output from at least one photodiode measuring at least a part of the light reflected from the surface.

14. A scanner according to any of the preceding items, wherein the at least one image is transformed to a three-dimensional model of the surface by means of at least one data processor.

15. A scanner according to any of the preceding items, furthermore comprising means for translation and/or rotation of the object relative to the projected light and the at least one image sensor.

16. A scanner according to item 15, wherein images are acquired for many positions during translation and/or rotation of the object, and all images being used to re-construct the three-dimensional model of the surface

17. A scanner according to any of the preceding items, wherein the detection means are semi-transparent and located co-axial with the at least one image sensor.

18. A scanner according to any of the preceding items, wherein the detection means are semi-transparent and located inside and/or adjacent to the at least one image sensor, preferably located behind a lens and in front of the image sensor.

19. A scanner according to any of the preceding items, wherein the detection means monitor the light reflected from at least one beam-splitter, preferably located co-axial with at least one image sensor.

20. A scanner according to any of the preceding items, wherein spatial filtering is applied to at least one light source, preferably prior to the projection means.

21. A scanner according to any of the preceding items, wherein at least one optical fibre is used between the at least one light source and the projection means.

22. A scanner according to any of the preceding items, further comprising prior information about the geometry of the object, such as prior information provided in a CAD model of the object.

23. A scanner according to any of the preceding items comprising a plurality of light sources, preferably providing light in different wave lengths.

24. A scanner according to item 23, wherein the plurality of light sources can be applied one at a time.

25. A scanner according to any of the preceding items, wherein the detection means comprises at least one optical band pass filter with a wavelength transparency window that at least comprises the wavelength of the light source while rejecting unwanted background light.

26. A scanner according to any of the preceding items, wherein the at least one image sensor is synchronised with the projection means.

27. A scanner according to any of the preceding items, further comprising means for exposing only part of the at least one image sensor.

28. A scanner according to any of the preceding items, further comprising a rolling shutter for exposing only part of the at least one image sensor, such as exposing only a subset of the rows and/or columns of an image sensor array.

29. A scanner according to item 28, wherein the rolling shutter is synchronised with the motion of the moving spot.

30. A scanner according to any of the items 1 to 29, further comprising polarizing optics, preferably located between the light source and the detection means.

31. A method for obtaining the three-dimensional geometry of at least a part of the surface of an object, said method comprising the steps of:
a. projecting light from at least one light source to a moving spot on the surface of the object, said at least one light source preferably being an adjustable laser light source,
b. recording at least one image of at least a part of the surface by means of at least one image sensor,
c. monitoring at least a part of the light reflected from the surface by means of at least one detector other than the at least one image sensor,
d. adjusting the intensity of the at least one light source based on the amount of light reflected from the surface, and
e. transforming the at least one image to a three-dimensional model of the surface.

32. A method according to item 31, whereby the detector monitors light independent of the at least one image sensor, and/or wherein adjustment of the intensity of the light source is provided independently of the image sensor.

33. A method according to any of the items 31 to 32, whereby the light is projected as a moving spot by means of at least one mirror adapted to perform at least a rotational movement.

34. A method according to item 33, wherein at least one mirror is a galvanometric mirror.

35. A method according to any of the items 31 to 34, wherein the projection means can be adjusted to vary the local intensity of light on the surface of the object.

36. A method according to any of the items 31 to 35, wherein the projection means can be adjusted by the regulation means.

37. A method according to any of the items 33 to 36, wherein the projection means are adjusted by means of varying the angular movement of the at least one mirror.

38. A method according to any of the items 31 to 37, wherein the moving spot appears as a pattern, such as a linear pattern, on the surface of the object.

39. A method according to any of the items 31 to 38, wherein the image sensor is a part of a camera.

40. A method according to any of the items 31 to 39, wherein power of the at least one light source can be adjusted faster than the frame rate of the at least one image sensor, preferably more than 2 times, more than 10 times, more than 50 and most preferably more than 100 times the frame rate of the at least one image sensor.

41. A method according to any of the items 31 to 40, wherein light reflected from the surface is detected by means of at least one photodiode.

42. A method according to any of the items 31 to 41, wherein the intensity of the at least one light source is adjusted by means of at least one feedback control system.

43. A method according to item 42, wherein the feedback control system adjusts the intensity of the at least one light source based on the output from at least one photodiode measuring at least a part of the light reflected from the surface.

44. A method according to any of the items 31 to 43, wherein the at least one image is transformed to a three-dimensional model of the surface by means of at least one data processor.

45. A method according to any of the items 31 to 44, furthermore comprising means for translation and/or rotation of the object relative to the projected light and the at least one image sensor.

46. A method according to item 45, wherein images are acquired for many positions during translation and/or rotation of the object, and all images are used to re-construct the three-dimensional model of the surface

47. A method according to any of the items 31 to 46, wherein the detection means are semi-transparent and located co-axial with the at least one image sensor.

48. A method according to any of the items 31 to 47, wherein the detection means are semi-transparent and located inside and/or adjacent to the at least one image sensor, preferably located behind a lens and in front of the image sensor.

49. A method according to any of the items 31 to 48, wherein the detection means monitor the light reflected from at least one beam-splitter, preferably located co-axial with at least one image sensor.

50. A method according to any of the items 31 to 49, wherein spatial filtering is applied to at least one light source, preferably prior to the projection means.

51. A method according to any of the items 31 to 50, wherein at least one optical fibre is used between the at least one light source and the projection means.

52. A method according to any of the items 31 to 51, further comprising prior information about the geometry of the object, such as prior information provided in a CAD model of the object.

53. A method according to any of the items 31 to 52 comprising a plurality of light sources, preferably providing light in different wave lengths.

54. A method according to item 53, wherein the plurality of light sources can be applied one at a time.

55. A method according to any of the items 31 to 54, wherein the detection means comprises at least one optical band pass filter with a wavelength transparency window that at least comprises the wavelength of the light source while rejecting unwanted background light.

56. A method according to any of the items 31 to 55, wherein the at least one image sensor is synchronised with the projection means.

57. A method according to any of the items 31 to 56, further comprising means for exposing only part of the at least one image sensor.

58. A method according to any of the items 31 to 57, further comprising a rolling shutter for exposing only part of the at least one image sensor, such as exposing only a subset of the rows and/or columns of an image sensor array.

59. A method according to item 58, wherein the rolling shutter is synchronised with the motion of the moving spot.

60. A method according to any of the items 31 to 59, wherein the light emitted from the light source is at least partly filtered before being projected on to the object, such as filtered by means of polarizing optics.

61. A method according to any of the items 31 to 60, wherein the light reflected from the object is at least partly filtered, such as filtered by means of polarizing optics.
